(19) United States
(12) Patent Application Publication
(10) Pub. No.: US 2017/0366656 A1
(43) Pub. Date: Dec. 21, 2017

(54) DEVICE AND METHOD OF PROVIDING SOCIAL NETWORK SERVICE WITH CLICK

(71) Applicant: SAMSUNG ELECTRONICS CO., LTD., Suwon-si (KR)

(72) Inventors: Pankaj AGARWAL, Suwon-si (KR); Kwang-choon KIM, Suwon-si (KR)

(73) Assignee: SAMSUNG ELECTRONICS CO., LTD., Suwon-si (KR)

(21) Appl. No.: 15/464,685

(22) Filed: Mar. 21, 2017

Related U.S. Application Data
(60) Provisional application No. 62/353,026, filed on Jun. 21, 2016.

(30) Foreign Application Priority Data
Nov. 24, 2016 (KR) 10-2016-0157429

(51) Int. Cl. H04M 1/725; G06Q 50/00; G06Q 30/06

(52) U.S. Cl. CPC H04M 1/7253; H04M 1/72561; G06Q 30/0623; G06Q 50/01; H04M 1/72552

(57) ABSTRACT

Provided are a mobile device and a method of providing content related to an external device. The method may include receiving from the external device an identifier regarding the external device and an identifier regarding a user input that is input to the external device; transmitting to a server the identifier regarding the external device and the identifier regarding the user input; receiving from the server content about the external device and the user input, based on the identifier regarding the external device and the identifier regarding the user input; and displaying the received content on a screen.

### CROSS-REFERENCE TO RELATED APPLICATIONS

This application claims priority from U.S. Provisional Application No. 62/353,026, filed on Jun. 21, 2016, in the United States Patent and Trademark Office, and Korean Patent Application No. 10-2016-0157429, filed on Nov. 24, 2016, in the Korean Intellectual Property Office, the disclosures of which are incorporated herein in their entireties by reference.

### BACKGROUND

### 1. Field

The present disclosure relates to a mobile device and method of providing a social media with one click, and more particularly, to a mobile device and method of providing content about an external device, based on an identifier regarding the external device and an identifier regarding a user input that is input to the external device.

### 2. Description of the Related Art

The development in network and multimedia technologies enabled users to have access to various services by using a mobile device. For example, the user may share information with other users who have certain interests by using the mobile device and may build new social relations.

However, a user using an existing mobile device has experienced inconvenience when she needs to search for a certain service by using the mobile phone to receive a service regarding an external device or a service regarding a product related to the external device. Thus, there exists a need for technology that enables a mobile device to easily provide a service regarding an external device.

### SUMMARY

Provided are a mobile device and a method of providing content about an external device, based on an identifier regarding the external device and an identifier regarding a user input that is input to the external device.

Provided are a mobile device and a method of registering an external device, based on a user input to the external device.

Additional aspects will be set forth in part in the description which follows and, in part, will be apparent from the description, or may be learned by practice of the presented embodiments.

According to an aspect of an exemplary embodiment, a mobile device may include: a memory storing a program; a communicator configured to exchange data with an external device and a server; and a processor configured to provide content about the external device by executing the program. The program may include instructions to perform: receiving, from the external device, an identifier regarding the external device and an identifier regarding a user input that is input to the external device; transmitting, to the server, the identifier regarding the external device and the identifier regarding the user input; receiving, from the server, content about the external device and the user input, based on the identifier regarding the external device and the identifier regarding the user input; and displaying the received content on a screen.

According to an aspect of an exemplary embodiment, a method of providing, by a mobile device, content about an external device, may include: receiving, from the external device, an identifier regarding the external device and an identifier regarding a user input that is input to the external device; transmitting, to a server, the identifier regarding the external device and the identifier regarding the user input; receiving, from the server, content about the external device and the user input, based on the identifier regarding the external device and the identifier regarding the user input; and displaying the received content on a screen.

According to an aspect of another embodiment, a non-transitory computer-readable recording medium has recorded thereon a program which, when executed by a computer, performs the above method.

### BRIEF DESCRIPTION OF THE DRAWINGS

The above and/or other aspects will become apparent and more readily appreciated from the following description of the embodiments, taken in conjunction with the accompanying drawings in which:

FIG. 1 is a diagram of an example of providing, by a mobile device, content about an external device, according to an exemplary embodiment;

FIG. 2 is a flowchart of a method of providing, by the mobile device, content about the external device, according to an exemplary embodiment;

FIG. 3 is a flowchart of a method of selecting content to be transmitted from a server to the mobile device, according to an exemplary embodiment;

FIG. 4A is a diagram of an example in which a user profile is managed by the server, according to an exemplary embodiment;

FIG. 4B is a flowchart of a method of managing, by the server, a user profile, according to an exemplary embodiment;

FIG. 5A is a flowchart of a method of receiving, by the mobile device, content about the external device when an identifier regarding a user input is a first identifier, according to an exemplary embodiment;

FIG. 5B is a diagram for explaining a method of receiving, by the mobile device, content about the external device, according to an exemplary embodiment;

FIGS. 6A to 6C are diagrams of examples of providing content about the external device when an identifier regarding a user input is a first identifier, according to an exemplary embodiment;

FIG. 7 is a flowchart of a method of receiving, by the mobile device, content about the external device when an identifier regarding a user input is a second identifier, according to an exemplary embodiment;

FIGS. 8A and 8B are diagrams of examples of providing content about the external device when an identifier regarding a user input is a second identifier, according to an exemplary embodiment;

FIG. 9A is a flowchart of a method of receiving, by the mobile device, content about an external device when an identifier regarding a user input is a third identifier, according to an exemplary embodiment;

FIG. 9B is a diagram for explaining a method of receiving, by the mobile device, content about the external device when an identifier regarding a user input is a third identifier, according to an exemplary embodiment;

FIGS. 10A to 10C are diagrams of examples of providing content about the external device when an identifier regarding a user input is a third identifier, according to an exemplary embodiment;

FIG. 11A is a flowchart of a method of receiving, by the mobile device, content about the external device when an identifier regarding a user input is an identifier indicating a collision between external devices, according to an exemplary embodiment;

FIG. 11B is a diagram for explaining a method of receiving, by the mobile device, content about the external device when an identifier regarding a user input is an identifier indicating a collision between external devices, according to an exemplary embodiment;

FIGS. 12A and 12B are diagrams of examples of providing content about the external device when an identifier regarding a user input is an identifier indicating a collision between external devices, according to an exemplary embodiment;

FIGS. 13A and 13B are diagrams of examples of registering the external device by the mobile device, according to an exemplary embodiment;

FIGS. 14 and 15 are block diagrams of the mobile device according to an exemplary embodiment; and

FIG. 16 is a block diagram of the server according to an exemplary embodiment.

### DETAILED DESCRIPTION

Reference will now be made in detail to exemplary embodiments, which are illustrated in the accompanying drawings, wherein like reference numerals refer to like elements throughout. In this regard, the present embodiments may have different forms and should not be construed as being limited to the descriptions set forth herein. In addition, for clarity, portions that are not related to the descriptions of the present disclosure are not illustrated in the drawings. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

It will be understood that when a component is referred to as being “connected to” another component, the component can be directly “connected to” the other component or “electrically connected to” the other component with intervening components therebetween. When a portion “includes” an element, another element may be further included, rather than excluding the existence of the other element, unless otherwise described. The word “exemplary” is used herein to mean “serving as an example or illustration.” Any aspect or design described herein as “exemplary” is not necessarily to be construed as preferred or advantageous over other aspects or designs.

Throughout the specification, an external device denotes any device corresponding to a product and may identify user inputs. Also, the external device may transmit, to a mobile device, an identifier regarding (e.g., associated with) the external device and an identifier regarding (e.g., associated with) a user input. The external device may include a user input unit including a sensor and/or a switch detecting a user input, a communicator communicating with the mobile device, and a controller controlling the user input unit and the communicator. However, a structure of the external device is not limited thereto. In addition, the external device may store information about a product associated with the external device. The information about a product may include at least one of a model name, a serial number, a manufacture number, and a product number of the product, but is not limited thereto. Furthermore, the external device may transmit the stored information to the mobile device.

In the specification, content may be various pieces of information or items which are obtained by generating texts, symbols, voices, sounds, images, videos, etc. in a digital manner and distributing the same. For example, content about an external device may include, but is not limited to, at least one of detailed information about using the product associated with the external device, a graphical user interface (GUI) for uploading data about the product associated with the external device, a GUI for communicating with another user who uses a product identical to the product associated with the external device, and a video including a scene in which products that are respectively related to different external devices are used together.

Moreover, an identifier regarding a user input that is input to the external device may indicate at least one of a button input, a touch input, and a motion input. For example, a user input identified by the external device may include at least one of an input of pressing a button on the external device short, an input of pressing the button long, an input corresponding to a motion of shaking the external device, and an input of colliding two external devices with each other. However, the user input is not limited thereto. The external device may transmit an identifier regarding each user input to the mobile device. Also, the server may select content to be transmitted to the mobile device, based on the identifier.

An identifier regarding the external device may be an identifier that represents the external device. In addition, external devices having the same model name may have the same identifier. For example, when products associated with external devices are construction toys, toys that are assembled as vehicles of the same type may have the same identifier regarding the external devices. However, types of identifiers regarding external devices are not limited thereto.

In the drawings, the product associated with the external device is illustrated as a toy, but its type is not limited thereto.

Hereinafter, the present disclosure will be described in detail by explaining embodiments of the present disclosure with reference to the attached drawings.

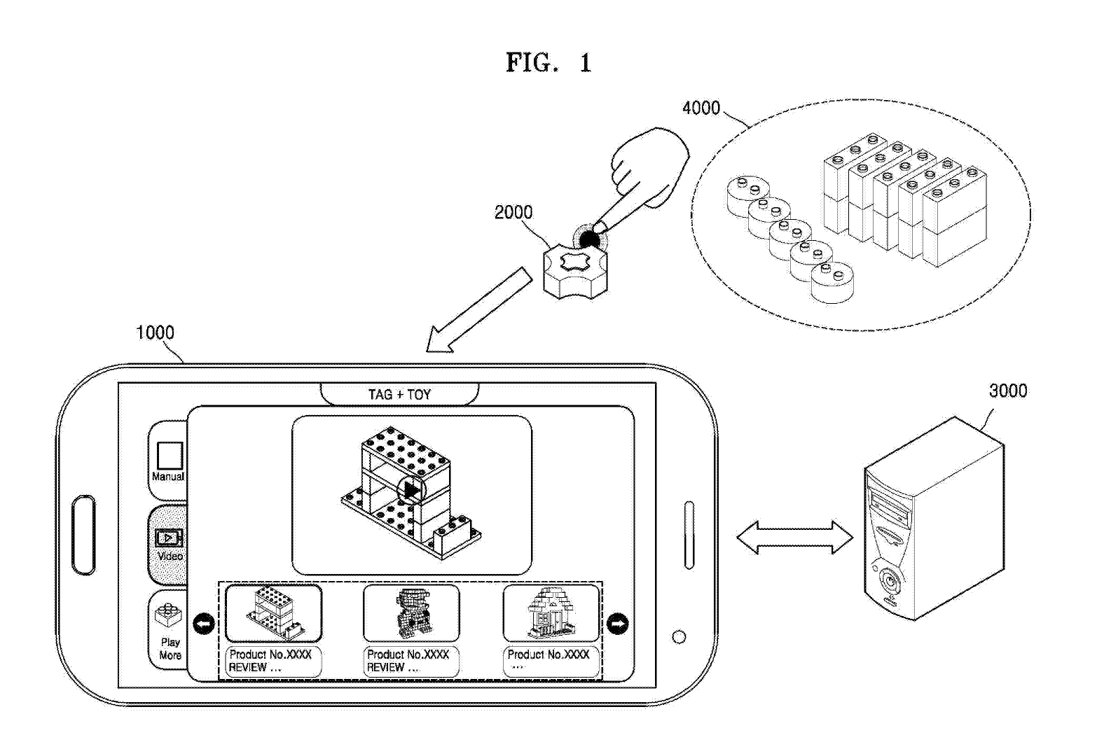

FIG. 1 is a diagram of an example of providing, by a mobile device 1000, content about an external device 2000 to a user, according to an exemplary embodiment.

Referring to FIG. 1, when a product associated with the external device 2000 is a toy 4000, the external device 2000 corresponding to the toy 4000 may transmit, to the mobile device 1000, an identifier regarding a user input and an identifier regarding the external device 2000 through short range communication, based on a user input that is input to the external device 2000. Also, the mobile device 1000 may transmit the identifier regarding the user input and the identifier regarding the external device 2000, which are received from the external device 2000, to a server 3000 and thus may send, to the server 3000, a request for providing content about the toy 4000 and the user input. Also, the server 3000 may provide the mobile device 1000 with content that is selected from among multiple pieces of content about the toy 4000 according to the identifier regarding the user input that is input to the external device 2000. The mobile device 1000 may display the content provided by the server 3000 on a screen of the mobile device 1000.

The toy 4000 may be a construction toy, a puzzle, a radio-controlled toy, a doll, a miniature figure, or the like, but is not limited thereto. For example, when the toy 4000 is a construction toy, the toy 4000 may include multiple blocks, and the user may complete a certain shape by assembling the blocks. Shapes of the toy 4000 may include a person, a building, a vehicle, a robot, etc., but are not limited thereto.

The external device 2000 may correspond to the toy 4000 and may receive a user input associated with the external device 2000. Also, the external device 2000 may be included in the toy 4000 or may be assembled with blocks of the toy 4000. However, a structure of the external device 2000 is not limited thereto.

The mobile device 1000 may be a portable computing device. For example, the mobile device 1000 may be, but is not limited to, a smart phone, a tablet personal computer (PC), a mobile phone, a personal digital assistant (PDA), a laptop computer, a media player, a global positioning system (GPS), an e-book reader, a navigation device, an MP3 player, a digital camera, or other mobile computing device. Also, the mobile device 1000 may be a wearable device, such as a watch, glasses, a hair band, a ring, or the like, which has communication data processing capabilities. However, the mobile device 1000 is not limited thereto.

In addition, the mobile device 1000 may communicate with the external device 2000, the server 3000, and other devices via a network in order to receive the identifier regarding the external device 2000 and the identifier regarding the user input, and provide the content about the toy 4000. In this case, the network may include a local area network (LAN), a wide area network (WAN), a value added network (VAN), a mobile radio communication network, a satellite communication network, and a combination thereof, and may indicate a data communication network that helps networked devices freely communicate with each other. The network may include wired Internet, wireless Internet, and a mobile wireless communication network. Wireless communication may be, for example, Wi-Fi, Bluetooth, Bluetooth low energy (BLE), ZigBee, Wi-Fi Direct (WFD), ultra wideband (UWB), infrared Data Association (IrDA), Near Field Communication (NFC), or the like, but is not limited thereto.

The server 3000 may provide the mobile device 1000 with tasks or content requested by the mobile device 1000. For example, the server 3000 may provide the mobile device 1000 with the content about the external device 2000 based on the identifier regarding the external device 2000 and the identifier regarding the user input that is input to the external device 2000, the identifiers being received from the mobile device 1000.

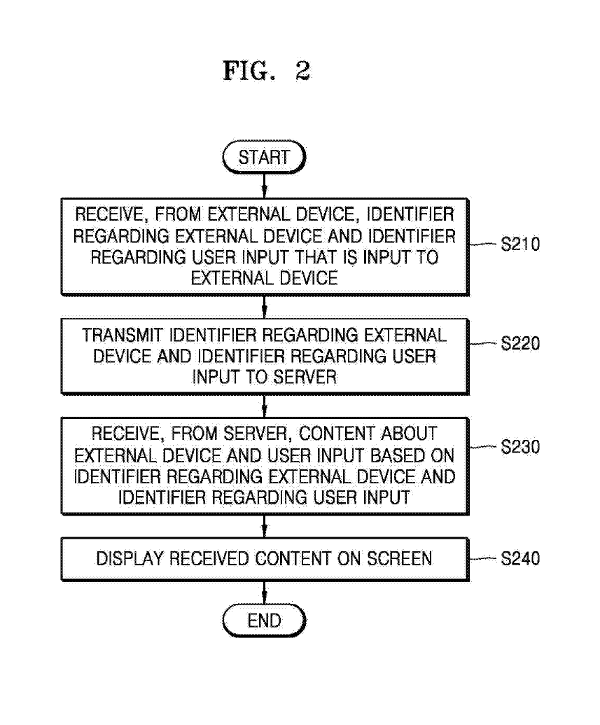

FIG. 2 is a flowchart of a method of providing, by the mobile device 1000, the content about the external device 2000, according to an exemplary embodiment.

In operation S210, the mobile device 1000 may receive, from the external device 2000, the identifier regarding the external device 2000 and the identifier regarding the user input that is input to the external device 2000. In this case, the identifier regarding the external device 2000 may be used to identify the external device 2000. The identifier regarding the user input may be an identifier corresponding to the user input in order to identify user inputs. For example, the identifier regarding the user input may indicate at least one of a button input, a touch input, and a motion input. The mobile device 1000 may communicate with the external device 2000 though short range communication in order to perform operation S210. In other words, as the mobile device 1000 comes close within a communication range of a short range communication module of the external device 2000, the mobile device 1000 and the external device 2000 may communicate with each other. For the short range communication, a communicator 1500 of the mobile device 1000 and a communicator of the external device 2000 may each include a short range communication module.

For example, when a user presses a button on the external device 2000 in vicinity of (e.g., within a threshold distance from) the mobile device 1000, the external device 2000 may transmit, to the mobile device 1000, the identifier regarding the external device 2000 and an identifier indicating a button input which are stored in the external device 2000.

In operation S220, the mobile device 1000 may transmit the identifier regarding the external device 2000 and the identifier regarding the user input to the server 3000. The mobile device 1000 may display the content about the toy 4000, or an application that manages the content about the toy 4000 may be installed in the mobile device 1000 by the user. After the application is installed, the mobile device 1000 may perform operation S220 as the identifier regarding the external device 2000 and the identifier regarding the user input are received.

In operation S230, the mobile device 1000 may receive, from the server 3000, the content about the external device 2000 and the user input based on the identifier regarding the external device 2000 and the identifier regarding the user input.

For example, when a product associated with the external device 2000 is the toy 4000, the content about the external device 2000 may include at least one of detailed information about using the toy 4000, a GUI for uploading data about the toy 4000, a GUI for communicating with another user who uses a toy 4000 that is identical to the toy 4000, and a video including a scene in which two toys 4000 are used. However, the present disclosure is not limited thereto.

Also, the server 3000 may match the identifier regarding the user input with content about the product associated with the external device 2000. For example, among identifiers regarding user inputs, a first identifier may be an identifier regarding a user input of pressing the button on the external device 2000 short. In this case, the server 3000 may match the first identifier with detailed information about using the product associated with the external device 2000.

By matching the content about the external device 2000 with the identifier regarding the user input, the server 3000 may select content based on the identifier regarding the user input which is received from the mobile device 2000.

In detail, when the identifier regarding the user input is the first identifier, the mobile device 1000 may receive the detailed information about using the product associated with the external device 2000 from the server 3000. When the product associated with the external device 2000 is the toy 4000, the detailed information may include at least one of an instruction manual of the toy 4000, a tutorial video, and information about another toy that is related to the toy 4000.

Also, when the identifier regarding the user input is a second identifier, the mobile device 1000 may receive the GUI for uploading the data about the product associated with the external device 2000 from the server 3000. When the product associated with the external device 2000 is the toy 4000, the data about the product associated with the external device 2000 may include at least one of an assembly instruction video associated with the toy 4000, a user review, and a rating.

Also, when the identifier regarding the user input is a third identifier, the mobile device 1000 may receive the GUI for communicating with another user who uses a product that is identical to the product associated with the external device 2000.

In addition, when the identifier regarding the user input indicates a user input of colliding (e.g., touching) the external device 2000 with another external device 2000, the mobile device 1000 may receive, from the server 3000, a video including a scene in which the products associated with the external devices 2000 are used together.

In operation S240, the mobile device 1000 may display the received content on the screen. For example, the received content may be received from the server 3000 in order to provide to a social media service.

Also, as the identifier regarding the external device 2000 and the identifier regarding the user input are received, the mobile device 1000 may display a GUI for determining whether to display the content about the external device 2000. In addition, based on a user input through the displayed GUI, the mobile device 1000 may determine whether to display the content. For example, when two mobile devices 1000 simultaneously receive the identifier regarding the external device 2000 within a communication coverage range of the external device 2000, the mobile devices 1000 may each determine whether to display the content about the external device 2000.

The content received from the mobile device 1000 may be content determined by the server 3000 based on the information about the product associated with the external device 2000. In particular, the external device 2000 may store the information about the product and may transmit the stored information to the mobile device 1000. The mobile device 1000 may transmit the information received from the external device 2000 to the server 3000. The server 3000 may determine content to be transmitted to the mobile device 1000 by using the information about the product which is received from the mobile device 1000. In this case, the information about the product may include at least one of a model name, a serial number, a manufacture number, and a product number of the product.

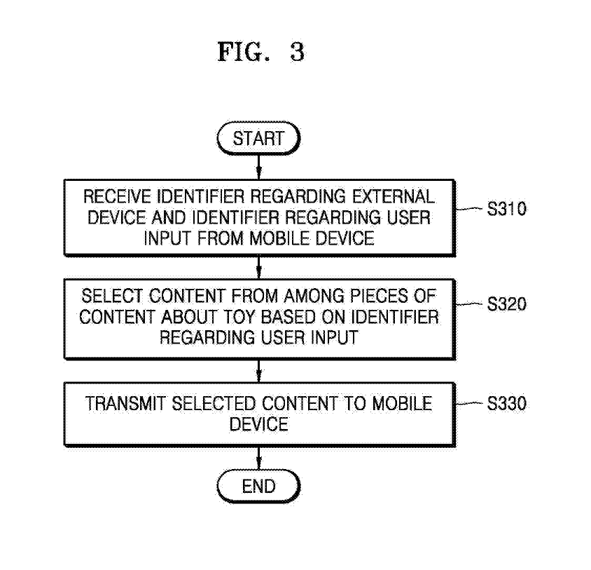

FIG. 3 is a flowchart of a method of selecting content to be transmitted from the server 3000 to the mobile device 1000, according to an exemplary embodiment.

In operation S310, the server 3000 may receive, from the mobile device 1000, the identifier regarding the external device 2000 and the identifier regarding the user input. In this case, the server 3000 may simultaneously receive the identifier regarding the external device 2000 and the identifier regarding the user input or may receive the same at a certain interval.

When the product associated with the external device 2000 is the toy 4000, the server 3000 may select the content to be transmitted to the mobile device 1000 from among pieces of the content about the toy 4000, based on the identifier regarding the user input in operation S320. In this case, the server 3000 may match the content about the toy 4000 with the identifier regarding the user input and may select the content to be transmitted to the mobile device 1000, based on a matching result.

For example, the server 3000 may retrieve pieces of content about the toy 4000 based on the identifier regarding the external device 2000. From among the retrieved pieces of content, the server 3000 may select content corresponding to the identifier regarding the user input. For example, when the product associated with the external device 2000 is a toy 4000 to be assembled as a vehicle, and when the identifier regarding the user input is an identifier corresponding to the input of a short press of the button on the external device 2000, the server 3000 may select at least one of the instruction manual of the toy 4000, the tutorial video, and information about another toy vehicle.

In operation S330, the server 3000 may transmit the selected content to the mobile device 1000.

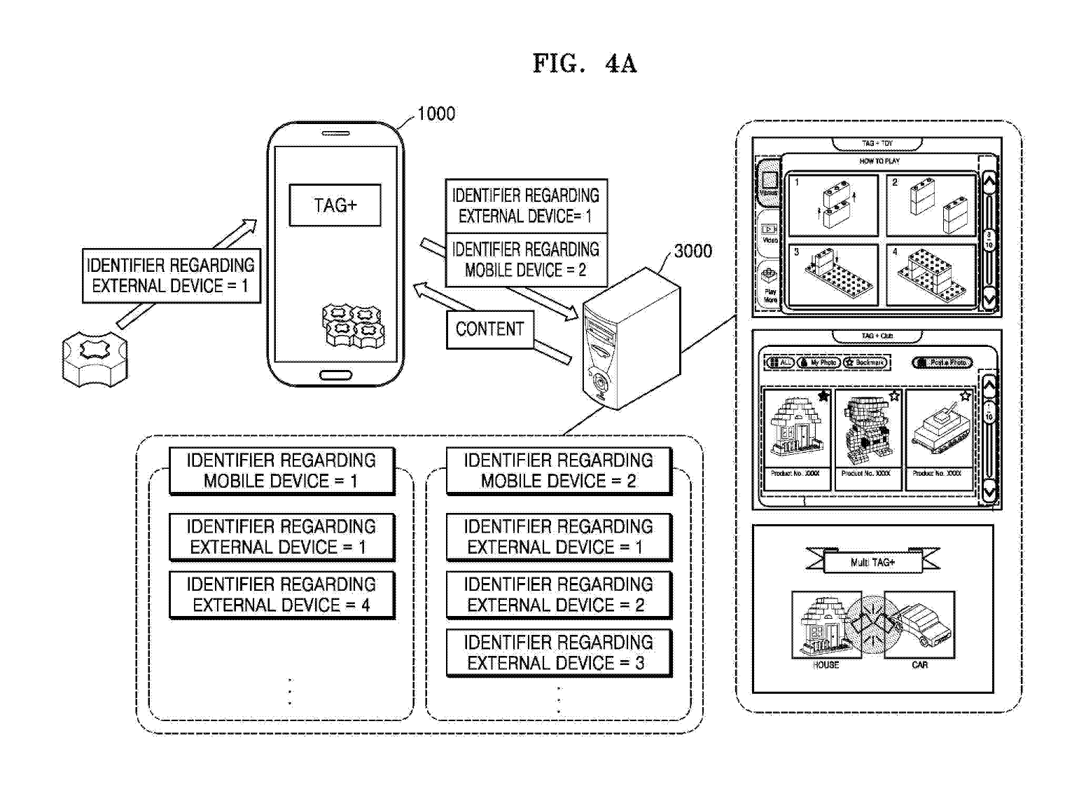

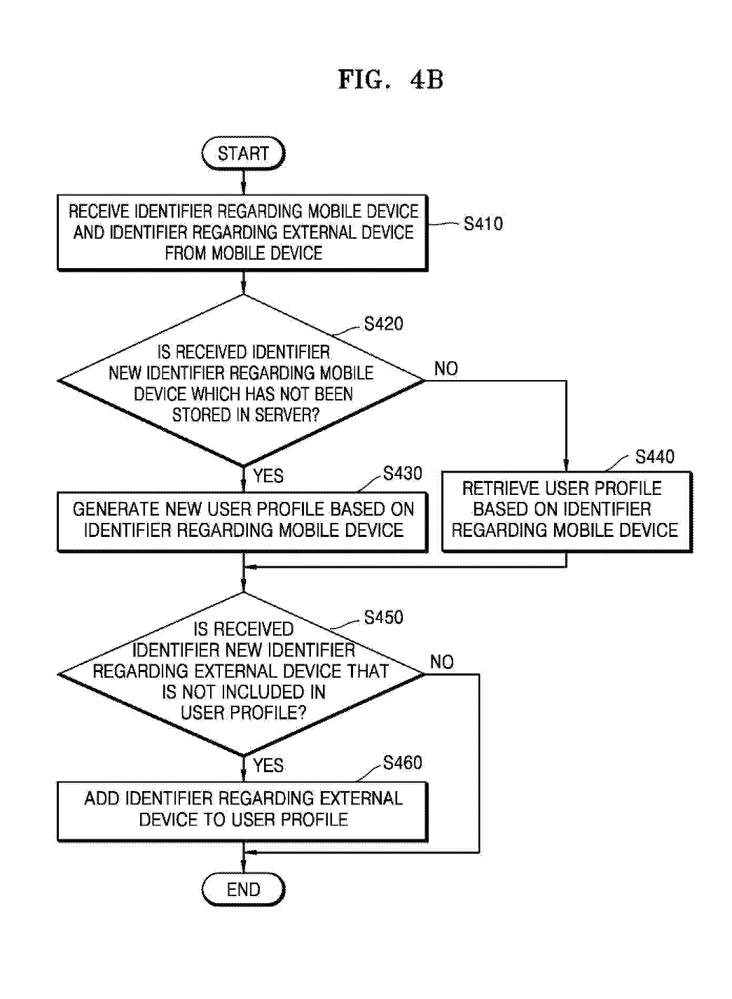

FIG. 4A is a diagram of an example in which a user profile is managed by the server 3000, according to an exemplary embodiment.

The external device 2000 may transmit the identifier regarding the external device 2000 to the mobile device 1000. In this case, the mobile device 1000 may transmit, to the server 3000, an identifier regarding the mobile device 1000 together with the identifier regarding the external device 2000 that is received from the external device 2000. The server 3000 may manage the user profile by using the identifier regarding the external device 2000 and the identifier regarding the mobile device 1000. In other words, the user profile may be tied to the mobile device 1000 instead of a user.

For example, the server 3000 may collect the identifier regarding the external device 2000 based on the identifier regarding the mobile device 1000 instead of a user identifier. Therefore, the user may receive, from the server 3000, content about the external device 2000 that the user has, by using the mobile device 1000 without a separate authentication process.

Referring to FIG. 4A, identifiers regarding external devices may be received from the mobile device 1000 having an identifier equals to 2. That is, the server 3000 may manage the user profile regarding the external device 2000 by using the identifier regarding the mobile device 1000 without the user identifier. Therefore, the server 3000 may provide the mobile device 1000 with the social media or the information about the external device 2000 by using a combination of the identifier regarding the mobile device 1000 and the identifier regarding the external device 2000. The social media may refer to an online service that allows users, who share interests in certain areas or activities, build social networks.

When the server 3000 adds the external device 2000 to the user profile, the mobile device 1000 may provide the user with a GUI for checking whether to add the external device 2000. Also, when the identifier regarding the mobile device 1000 is changed, the mobile device 1000 may provide the user with a GUI for checking whether to change the mobile device 1000.

FIG. 4B is a flowchart of a method of managing, by the server 3000, a user profile, according to an exemplary embodiment.

The server 3000 may generate and manage the user profile by using the identifier regarding the mobile device 1000 and the identifier regarding the external device 2000 which are received from the mobile device 1000. In other words, the server 3000 may manage the user profile by using the identifier regarding the mobile device 1000 instead of the user identifier. The server 3000 may collect information about a product that a certain user has, by using the user profile.

Referring to FIG. 4B, in operation S410, the server 3000 may receive the identifier regarding the mobile device 1000 and the identifier regarding the external device 2000. The server 3000 may simultaneously receive the identifier regarding the external device 2000 and the identifier regarding the user input from the mobile device 1000 or may receive them separately at a certain time interval.

In operation S420, the server 3000 may determine whether the received identifier regarding the mobile device 1000 is a new identifier regarding the mobile device 1000 which has not been stored in the server 3000.

When the received identifier regarding the mobile device 1000 is the new identifier regarding the mobile device 1000 according to a determination result obtained in operation S420, the server 3000 may generate a new user profile based on the identifier regarding the mobile device 1000 in operation S430.

When the received identifier regarding the mobile device 1000 is an identifier regarding the mobile device 1000, which is already stored in the server 3000, according to the determination result obtained in operation S420, the server 3000 may retrieve the user profile based on the mobile device 1000 in operation S440.

In operation S450, the server 3000 may determine whether the received identifier regarding the external device 2000 is a new identifier regarding the external device 2000 which is not included in the user profile.

When the received identifier regarding the external device 2000 is a new identifier regarding the external device 2000 according to a determination result obtained in operation S450, the server 3000 may add the identifier regarding the external device 2000 to the user profile in operation S460.

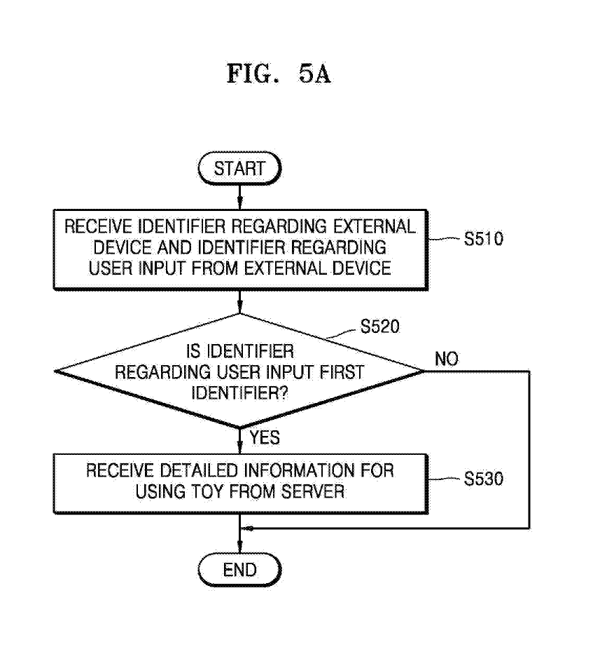

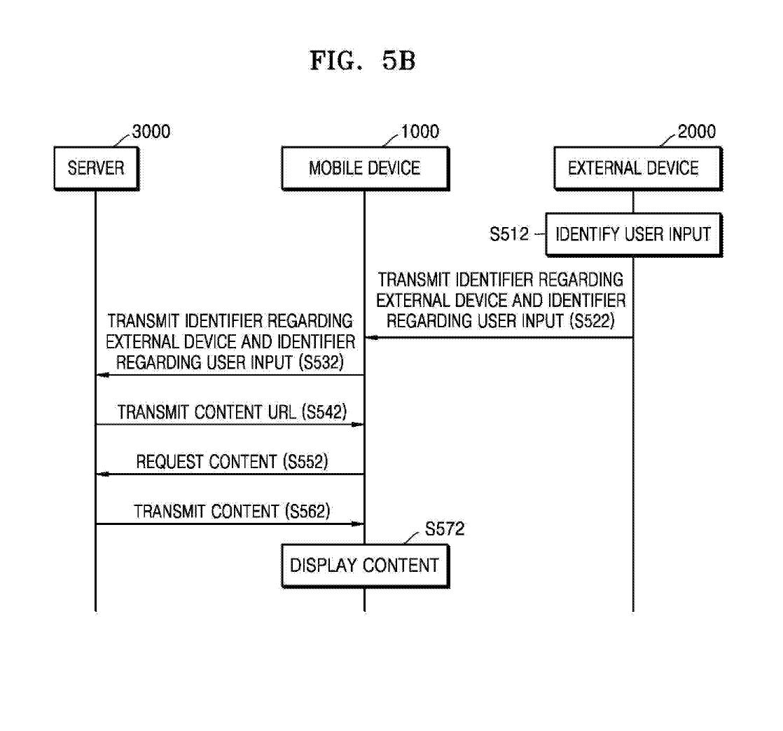

FIG. 5A is a flowchart of a method of receiving, by the mobile device 1000, the content about the external device 2000 when the identifier regarding the user input is the first identifier, according to an exemplary embodiment.

In operation S510, the mobile device 1000 may receive, from the external device 2000, the identifier regarding the external device 2000 and the identifier regarding the user input that is input to the external device 2000. Since operation S510 corresponds to operation S210 of FIG. 2, detailed descriptions thereof are omitted.

In operation S520, the mobile device 1000 may determine whether the received identifier regarding the user input is the first identifier. For example, the first identifier may be an identifier corresponding to the user input of pressing the button on the external device 2000 short. However, the present disclosure is not limited thereto.

When the received identifier regarding the user input is the first identifier according to a determination result obtained in operation S520, the mobile device 1000 may receive detailed information for using the toy 4000 from the server 3000, in operation S530. For example, the detailed information for using the toy 4000 may include at least one of the instruction manual of the toy 4000, the tutorial video, and information about another toy associated with the toy 4000. However, the present disclosure is not limited thereto.

FIG. 5B is a diagram for explaining a method of receiving, by the mobile device 1000, the content about the external device 2000, according to an exemplary embodiment.

In operation S512, the external device 2000 may identify a user input. For example, the external device 2000 may identify a user input of pressing the button on the external device 2000 long or short.

In operation S522, the external device 2000 may transmit the identifier regarding the external device 2000 and the identifier regarding the user input to the mobile device 1000. The identifier regarding the user input may be an identifier corresponding to the user input that is identified in operation S512.

In operation S532, the mobile device 1000 may transmit the identifier regarding the external device 2000 and the identifier regarding the user input to the server 3000. Also, the mobile device 1000 may transmit an additional identifier regarding the mobile device 1000 to the server 3000 such that the server 3000 may manage the user profile.

In operation S542, the server 3000 may transmit, to the mobile device 1000, a uniform resource locator (URL) of content about the identifier regarding the external device 2000 and the identifier regarding the user input. The URL may indicate an address used to access the content. The content may be detailed information about using the product associated with the external device 2000. For example, the detailed information may include at least one of a manual (e.g., an instruction manual) of the product, a tutorial video of the product, and product-related information. Also, the content may be a GUI for uploading data about the product associated with the external device 2000.

In operation S552, the mobile device 1000 may send a request for transmitting the content based on the URL received from the server 3000.

In operation S562, the server 3000 may transmit the content to the mobile device 1000.

In operation S572, the mobile device 1000 may display the content received from the server 3000.

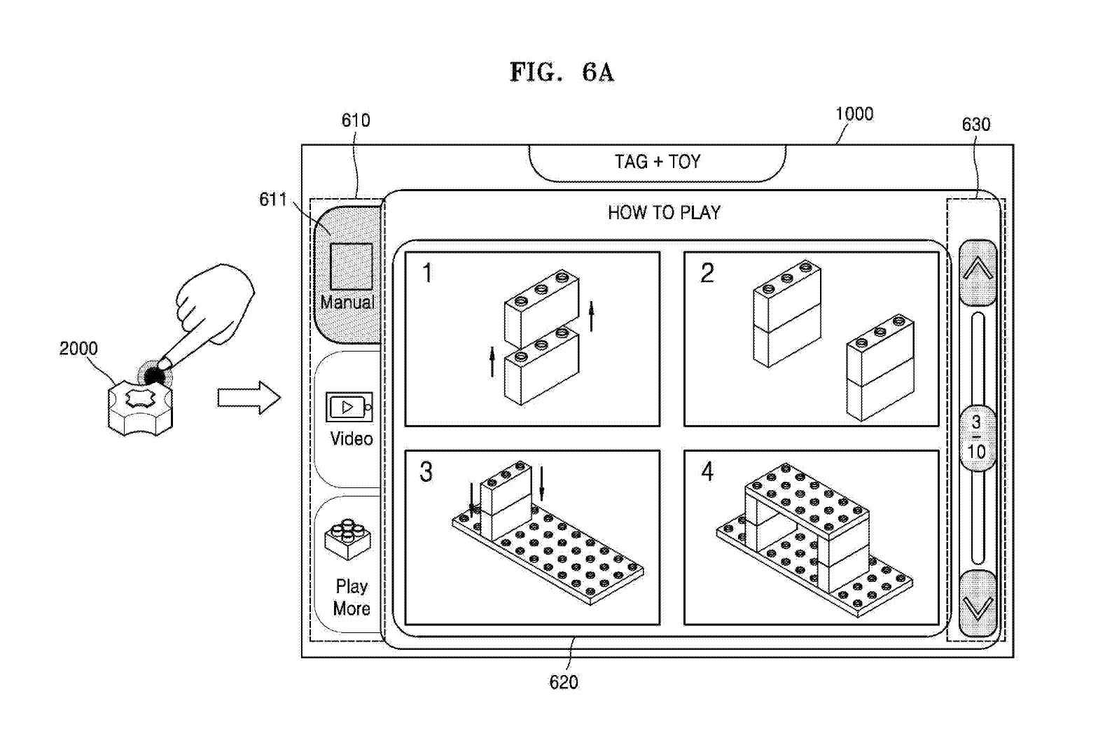

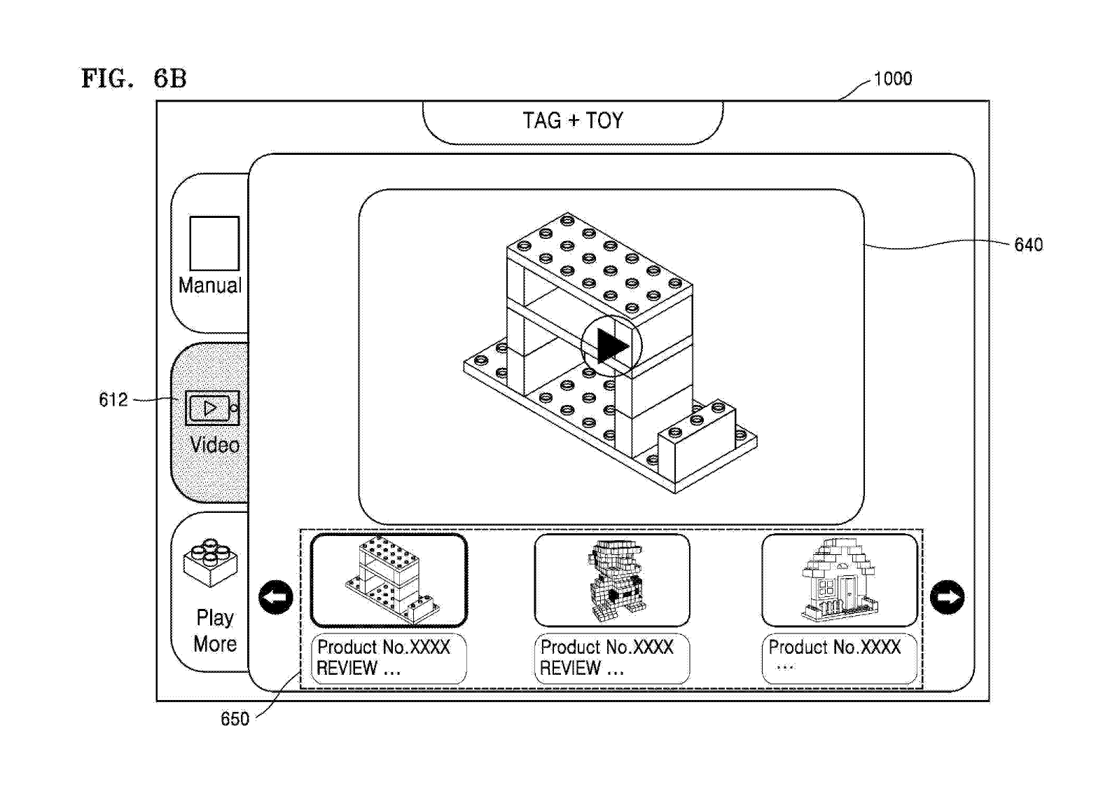

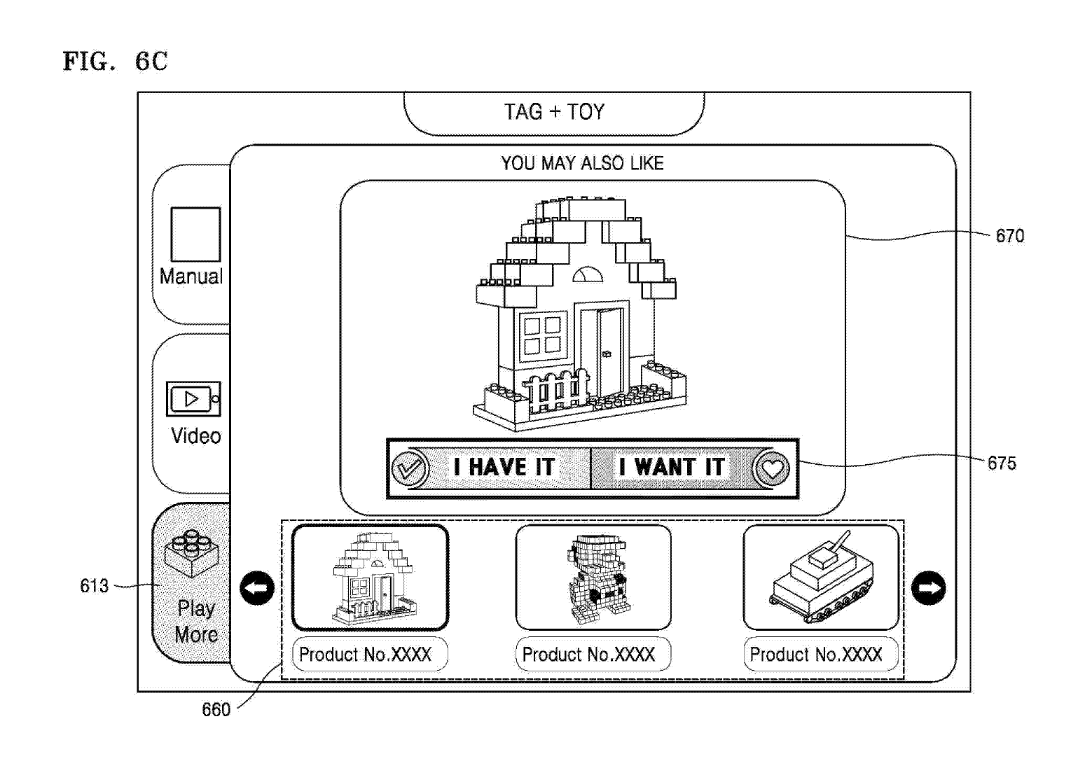

FIGS. 6A to 6C are diagrams of examples of providing content about the external device 2000 when the identifier regarding the user input is the first identifier, according to an exemplary embodiment.

For example, when an input of pressing the button on the external device 2000 short is identified, the external device 2000 may transmit, to the mobile device 1000, an identifier regarding the user input as the first identifier. In this case, the mobile device 1000 may receive the detailed information for using the toy 4000 from the server 3000 and may display the detailed information on the screen.

Referring to FIG. 6A, when the identifier regarding the user input is the first identifier, the mobile device 1000 may display a manual (e.g., instruction manual) 620 of the toy 4000. In this case, a manual menu 611 may be highlighted on a menu tab 610. The manual 620 may include an assembly order of the toy 4000, safety warnings, etc., but is not limited thereto. Also, the user may move the screen by using a scroll bar 630, but a detailed structure of the screen is not limited thereto.

Referring to FIG. 6B, the mobile device 1000 may display a tutorial video of the toy 4000. In this case, a video menu 612 regarding the tutorial may be highlighted on the menu tab 610. The mobile device 1000 may enlarge a video 640 included in a video list 650 and may display the enlarged video 640 based on a user input. For example, the tutorial video of the toy 4000 may include, but is not limited to, a product introduction video, an assembly method video, a video including user reviews, etc.

Referring to FIG. 6C, the mobile device 1000 may display information about another toy related to the toy 4000. In this case, a menu 613 showing the information about the other toy may be highlighted on the menu tab 610. In addition, the mobile device 1000 may enlarge an image 670 of a toy, which is selected from a toy list 660 that is related to the toy 4000, and may display the enlarged image 670 based on a user input. Furthermore, the mobile device 1000 may display a GUI 675 for receiving a user input regarding whether the user has or wants other toys related to the toy 4000 and a user input regarding preference. In this case, the server 3000 may collect, from the mobile device 1000, whether the user has another toy or preference regarding the toy 4000 so as to analyze a certain user pattern.

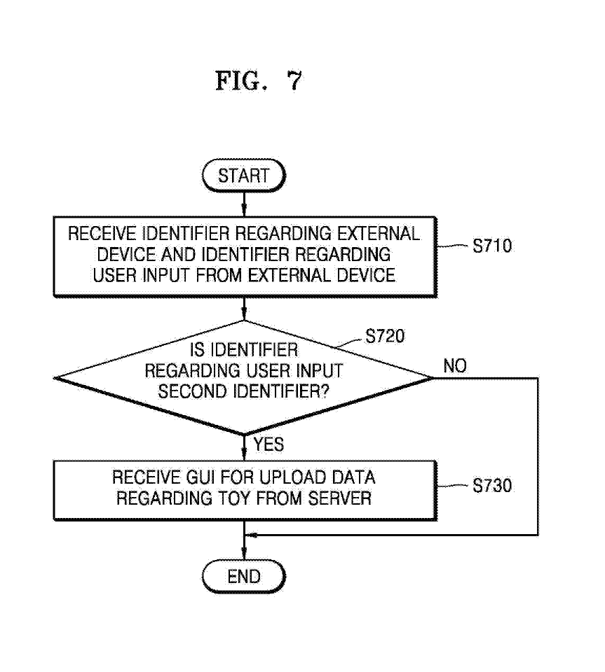

FIG. 7 is a flowchart of a method of receiving, by the mobile device 1000, the content about the external device 2000 when the identifier regarding the user input is the second identifier, according to an exemplary embodiment.

In operation S710, the mobile device 1000 may receive the identifier regarding the external device 2000 and the identifier regarding the user input that is input to the external device 2000, from the external device 2000. Since operation S710 corresponds to operation S210 of FIG. 2, detailed descriptions thereof are omitted.

In operation S720, the mobile device 1000 may determine whether the received identifier regarding the user input is a second identifier. For example, the second identifier may be an identifier corresponding to a user input of long pressing the button on the external device 2000, but is not limited thereto.

When the received identifier regarding the user input is the second identifier according to a determination result obtained in operation S720, the mobile device 1000 may receive a GUI for uploading the data about the toy 4000 from the server 3000 in operation S730. For example, the mobile device 1000 may provide a social media service associated with the toy 4000. For the example, the social media service may include posting a message, commenting on a product, indicating preference or dislike for the product, sharing the product, etc. The mobile device 1000 may upload the data about the toy 4000 to the server 3000 or receive the data about the toy 4000 from the server 3000 in order to provide the social media service. In this case, the data about the toy 4000 may include an assembly instruction video for the user, user reviews, and grades, but the data is not limited thereto.

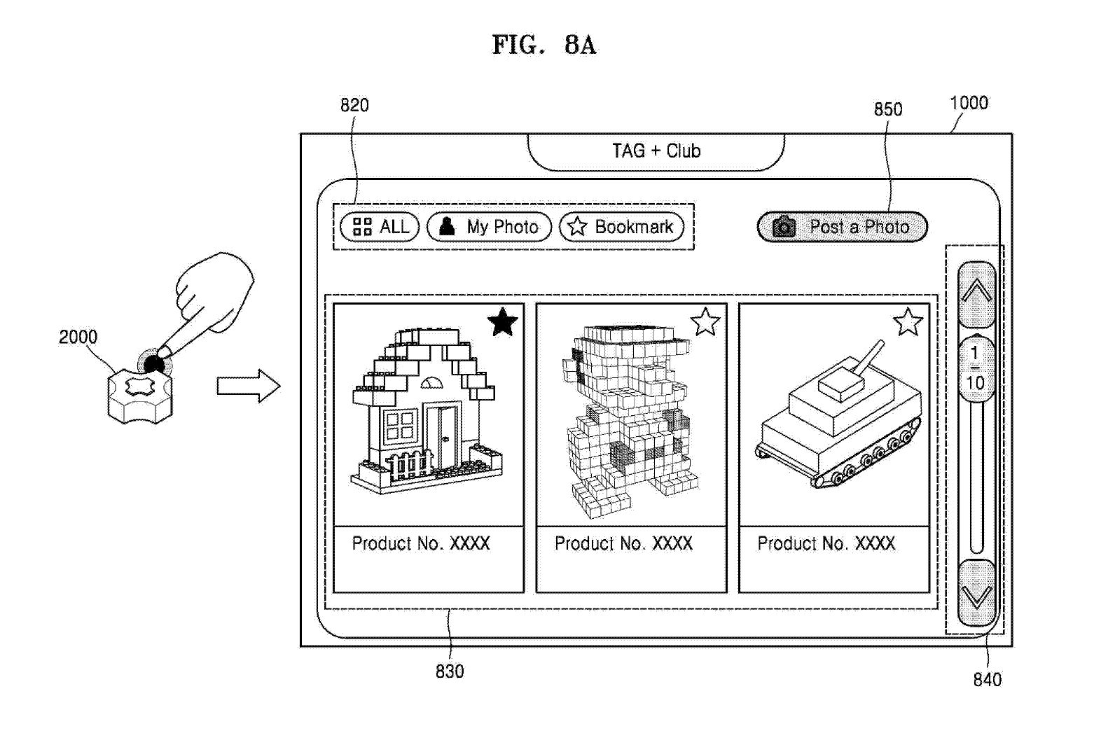

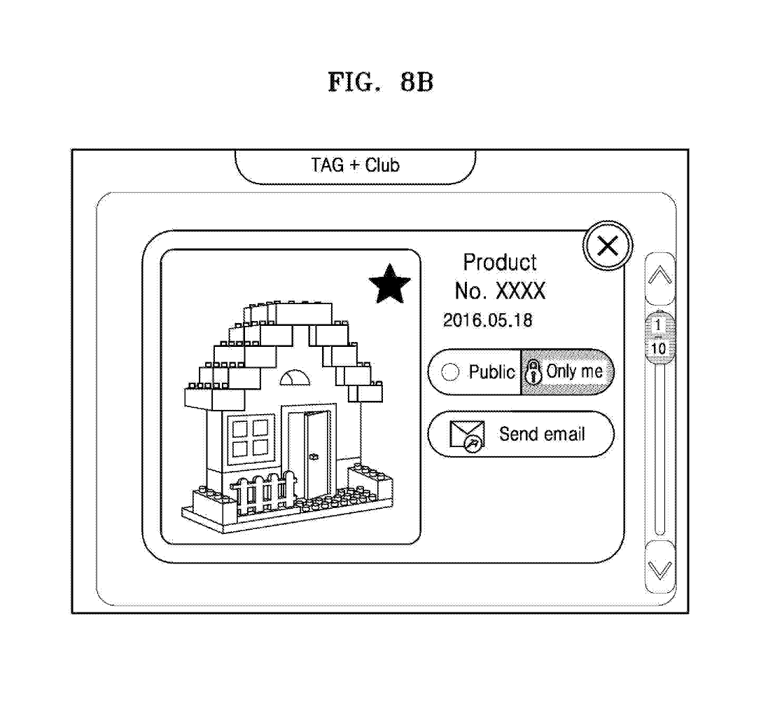

FIGS. 8A and 8B are diagrams of examples of providing the content about the external device 2000 when the identifier regarding the user input is the second identifier, according to an exemplary embodiment.

For example, when an input of long pressing a button on the external device 2000 is identified, the external device 2000 may transmit the second identifier as the identifier regarding the user input to the mobile device 1000. In this case, the mobile device 1000 may receive, from the server 3000, the GUI for uploading the data about the toy 4000 and may display the GUI on the screen.

Referring to FIG. 8A, when the identifier regarding the user input is the second identifier, the mobile device 1000 may display a data list 830 regarding the toy 4000 that is uploaded by users. The data list 830 may include images or thumbnails, but is not limited thereto. Since a scroll bar 840 corresponds to the scroll bar 630 of FIG. 6A, detailed descriptions thereof are omitted.

The mobile device 1000 may display a filter mode 820 of the data list 830 regarding the toy 4000. In detail, the filter mode 820 may include a mode of displaying all pieces of data about the toy 4000, a mode of displaying only data that is uploaded by the mobile device 1000, a mode of displaying only data that is set as a bookmark, or the like. However, the filter mode 820 is not limited thereto. In addition, the mobile device 1000 may display an image upload button 850. When the image upload button 850 is pressed, the mobile device 1000 may capture an image and may upload the captured image to the server 3000.

The mobile device 1000 may enlarge one piece of data included in the data list 830 regarding the toy 4000 and may display the enlarged piece of data. Referring to FIG. 8B, the mobile device 1000 may display data about the toy 4000, whether the data is set as a bookmark, whether the data is accessible to other users, an email sending button, or the like. However, the present disclosure is not limited thereto.

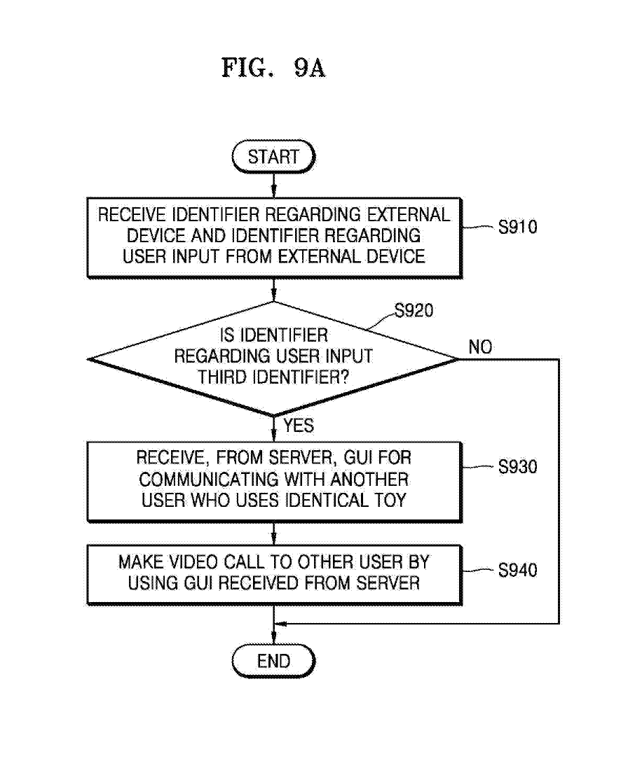

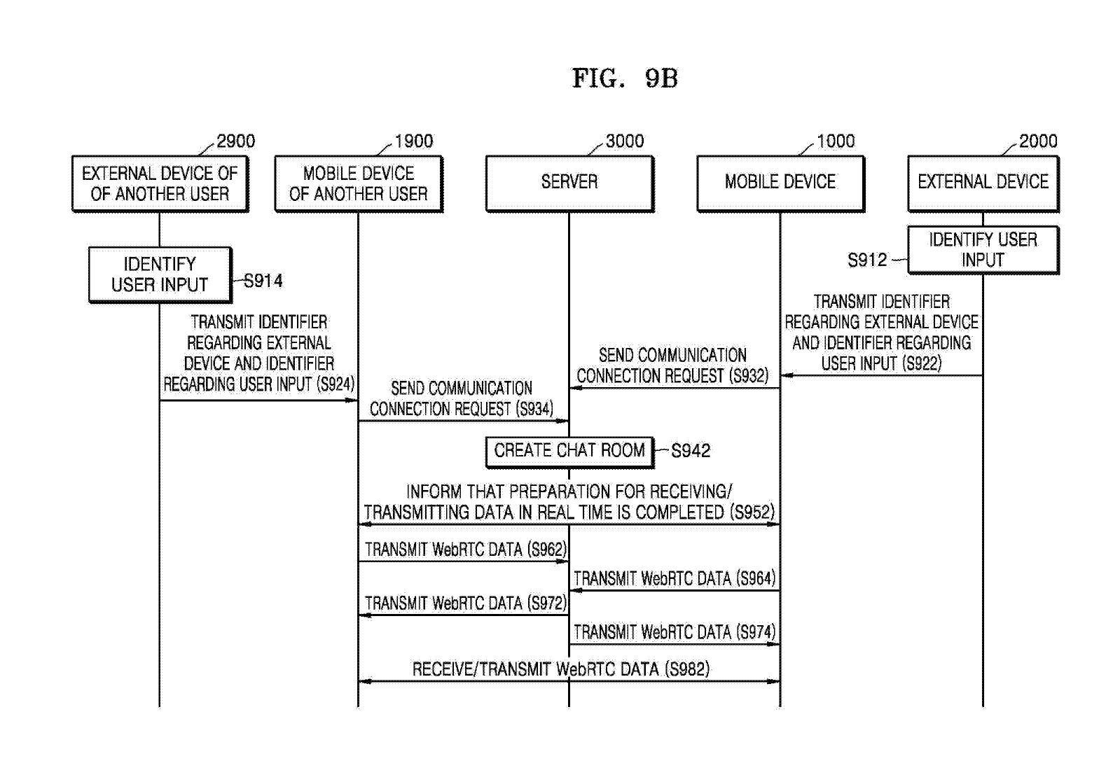

FIG. 9A is a flowchart of a method of receiving, by the mobile device 1000, the content about the external device 2000 when the identifier regarding the user input is the third identifier, according to an exemplary embodiment.

In operation S910, the mobile device 1000 may receive, from the external device 2000, the identifier regarding the external device 2000 and the identifier regarding the user input that is input to the external device 2000. Since operation S910 corresponds to operation S210 of FIG. 2, detailed descriptions thereof are omitted.

In operation S920, the mobile device 1000 may determine whether the received identifier regarding the user input is the third identifier. For example, the third identifier may correspond to a user input of shaking the external device 2000, but is not limited thereto.

When the received identifier regarding the user input is the third identifier according to a determination result obtained in operation S920, the mobile device 1000 may receive, from the server 3000, a GUI for communicating with another user who uses a toy that is identical to the toy 4000, in operation S930.

In operation S940, the mobile device 1000 may make a video call to the other user by using the GUI received from the server 3000.

FIG. 9B is a diagram for explaining a method of receiving, by the mobile device 1000, the content about the external device 2000 when the identifier regarding the user input is the third identifier, according to an exemplary embodiment.

In operation S912, the external device 2000 may identify a user input. For example, the external device 2000 may identify a user input of shaking the external device 2000.

In operation S922, the external device 2000 may transmit the identifier regarding the external device 2000 and the identifier regarding the user input to the mobile device 1000. For example, when the user input of shaking the external device 2000 is identified, the external device 2000 may transmit the identifier regarding the user input to the third identifier.

In operation S932, the mobile device 1000 may send a communication connection request to the server 3000. When the communication connection request is sent, the mobile device 1000 may transmit the identifier regarding the external device 2000 and the identifier regarding the user input to the server 3000.

Since operations S914, S924, and S934 respectively correspond to operations S912, S922, and S932, detailed descriptions thereof are omitted.

In operation S942, the server 3000 may create a chat room so as to exchange data in real-time with a mobile device 1900 of another user which transmits an identifier regarding an external device, the identifier being identical to the identifier regarding the external device 2000 and being transmitted by the mobile device 1000.

In operation S952, the server 3000 may inform that preparation for receiving/transmitting data to the mobile device 1000 and the mobile device 1900 in real time is completed.

In operation S962, the mobile device 1900 may transmit Web Real-Time Communication (WebRTC) data to the server 3000. The WebRTC data may be data according to communication protocols and standards regarding application programming interfaces that enable real-time communication. That is, the mobile device 1900 may transmit texts, voices, images, etc. in real time by using a WebRTC data form.

In operation S972, the server 3000 may transmit the WebRTC data received from the mobile device 1000, to the mobile device 1900. However, the communication between the mobile device 1000, mobile device 1900, and the server 3000 is not limited thereto, other real-time communication protocols may be used.

Since operations S964 and S974 respectively correspond to operations S962 and S972, detailed descriptions thereof are omitted.

In operation S982, the mobile device 1000 and the mobile device 1900 may directly receive/transmit the WebRTC data. For example, the mobile device 1000 and the mobile device 1900 may receive/transmit the WebRTC data via a Traversal Using Relay NAT (TURN) server and thus may make a video call.

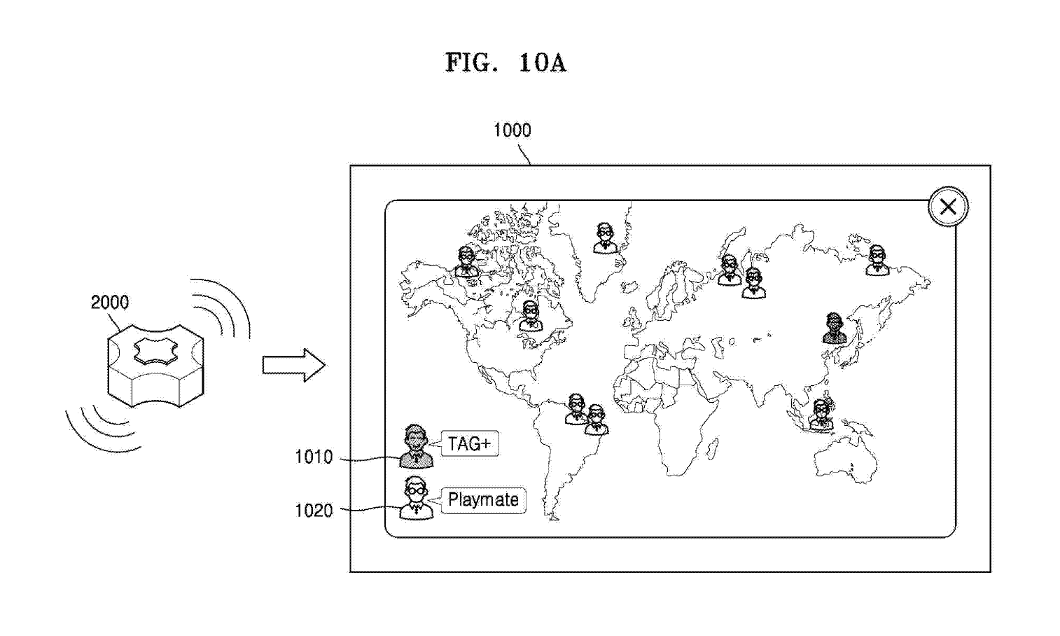

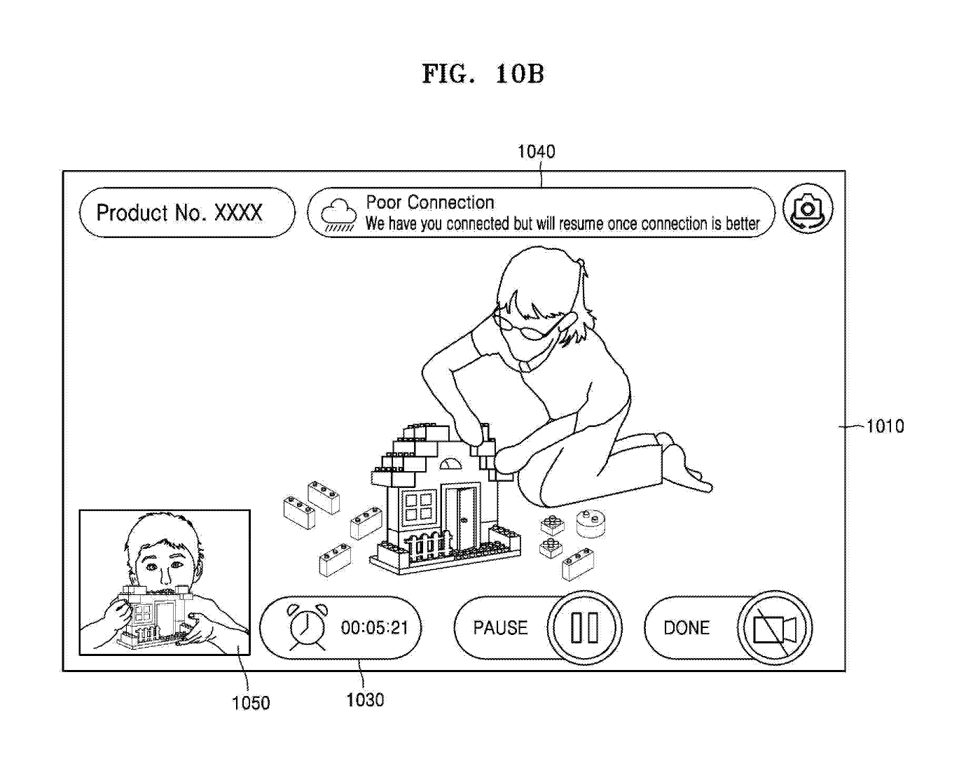

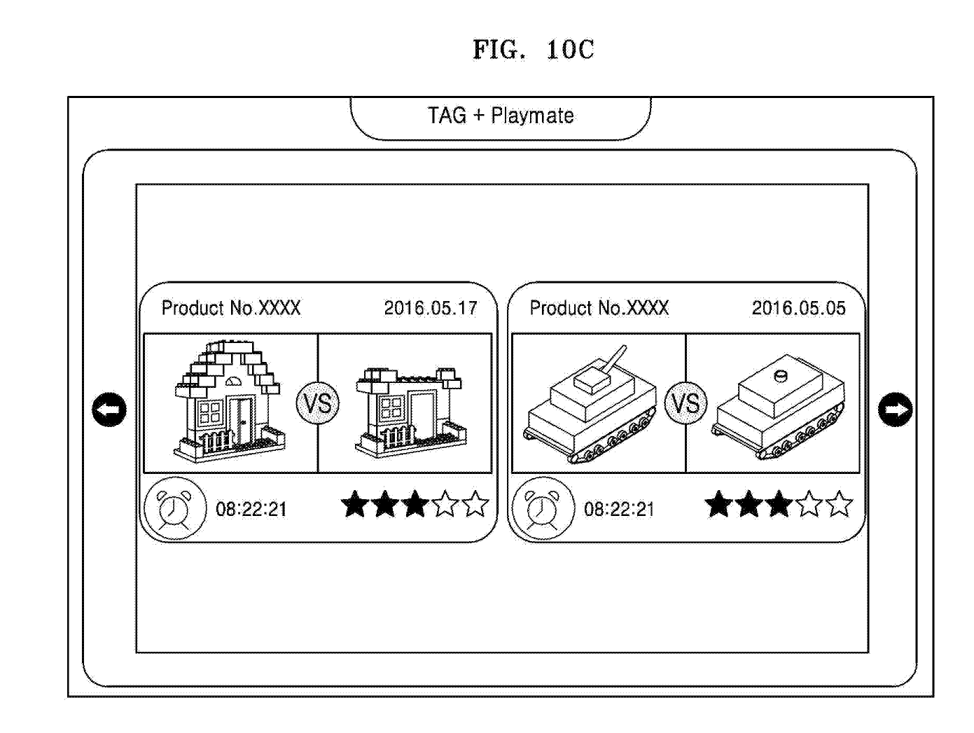

FIGS. 10A to 10C are diagrams of examples of providing the content about the external device 2000 when the identifier regarding the user input is the third identifier, according to an exemplary embodiment.

For example, when the input of shaking the external device 2000 is identified, the external device 2000 may transmit, to the mobile device 1000, the third identifier as the identifier regarding the user input. In this case, the mobile device 1000 may receive, from the server 3000, the GUI for communicating with the other user who uses the toy 4000 that is identical to the toy 4000, and may display the GUI on the screen.

Referring to FIG. 10A, when the identifier regarding the user input is the third identifier, the mobile device 1000 may display a first icon 1010 at a location corresponding to a location of the mobile device 1000. In addition, second icons 1020 may be displayed at locations corresponding to locations of other users who use the toys 4000 that are identical to the toy 4000.

Also, when one of the second emoticons 1020 is selected by the user, the mobile device 1000 may send a video call request to a user corresponding to the selected second icon 1020. Also, the mobile device 1000 may receive a video call from another user.

For example, referring to FIG. 10B, the mobile device 1000 may make a video call to another user. In this case, an image 1010 captured by the other user and an image 1050 captured by the mobile device 1000 may be displayed, but locations of the images 1010 and 1050 are not limited. In addition, the mobile device 1000 may provide a stopwatch 1030 and communication status information 1040 which are used when two users, who talk to each other on the video phone, play.

Referring to FIG. 10C, after the video call ends, the mobile device 1000 may display a GUI for managing a video call review by using snapshots obtained during the video call. For example, the mobile device 1000 may display snapshots showing assembly of a house, the snapshots being obtained during a video call made on May 17, 2016. In this case, time information obtained by the stopwatch 1030, a user rating, etc. may be displayed.

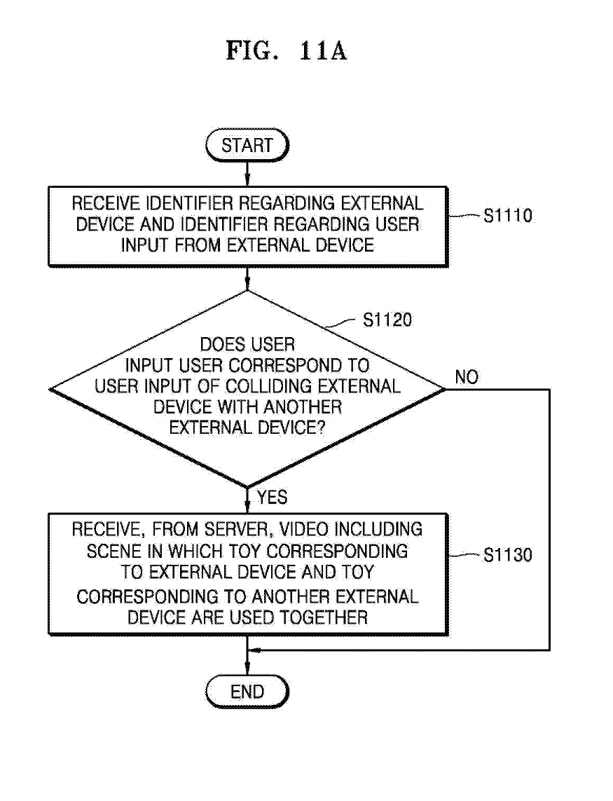

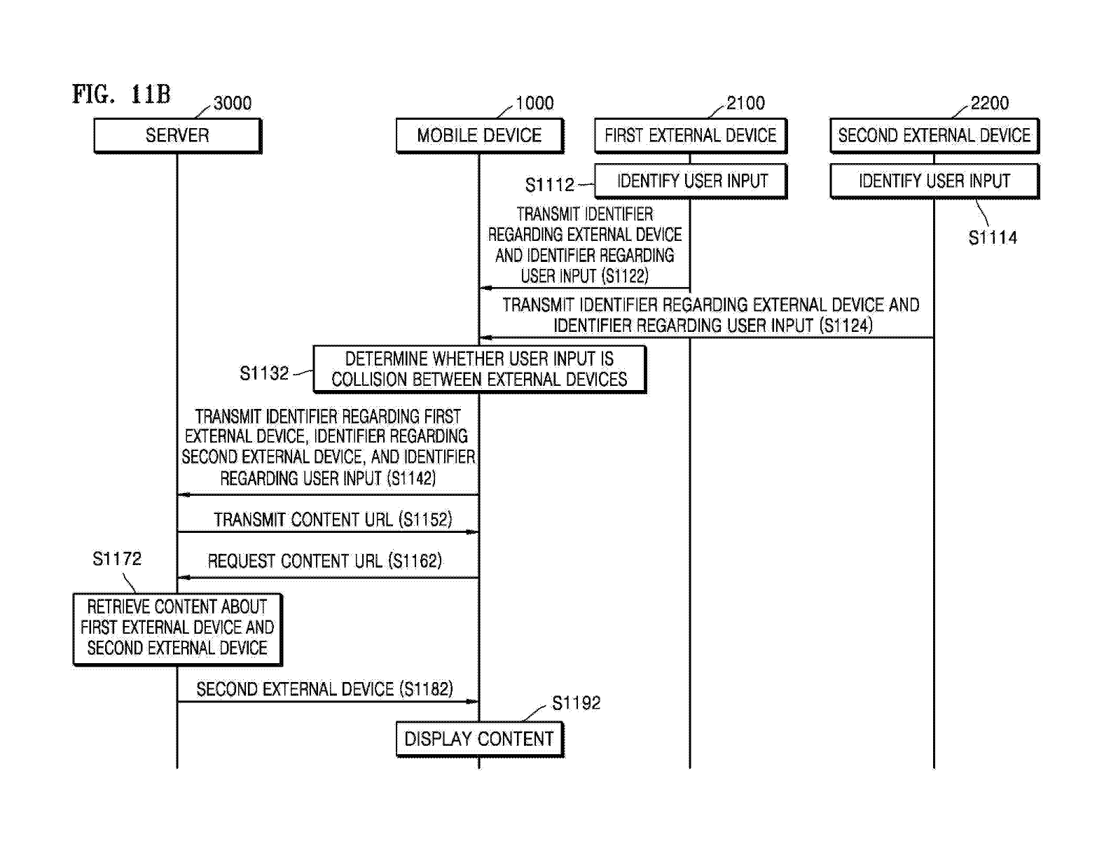

FIG. 11A is a flowchart of a method of receiving, by the mobile device 1000, the content about the external device 2000 when the identifier regarding the user input is an identifier indicating a collision between external devices, according to an exemplary embodiment.

In operation S1110, the mobile device 1000 may receive, from the external device 2000, the identifier regarding the external device 2000 and the identifier regarding the user input that is input to the external device 2000. Operation S1110 corresponds to operation S210 of FIG. 2, and detailed descriptions thereof are omitted.

In operation S1120, the mobile device 1000 may determine whether the user input is a user input of colliding (e.g., touching) the external device 2000 with another external device 2000. For example, when an identifier regarding a user input corresponding to an input of shaking for a certain time period, is received from the external devices 2000, the mobile device 1000 may determine that the user input indicates the collision between the external devices. However, a method of determining a user input as a collision between external devices is not limited thereto.

When the identifier regarding the user input is the identifier indicating the collision between the external devices according to a determination result obtained in operation S1120, the mobile device 1000 may receive, from the server 3000, a video including a scene in which two toys 4000 are used together, in operation S1130.

FIG. 11B is a diagram for explaining a method of receiving, by the mobile device 1000, the content about a first external device 2100 and a second external device 2200 when the identifier regarding the user input is the identifier indicating the collision between the first and second external devices 2100 and 2200, according to an exemplary embodiment.

In operation S1112, the first external device 2100 may identify a user input. For example, the first external device 2100 may identify a user input of shaking the first external device 2100.

In operation S1122, the first external device 2100 may transmit the identifier regarding the first external device 2100 and the identifier regarding the user input to the mobile device 1000.

Since operations S1114 and S1124 respectively correspond to operations S1112 and S1122, detailed descriptions thereof are omitted. The timing of operations S1114 and S1124, or of operations S1112 and S1122 may substantially coincide or occur at different times.

In operation S1132, the mobile device 1000 may determine whether the user input is generated due to a collision between the first and second external devices 2100, 2200, based on identifiers regarding user inputs received from the first external device 2100 and the second external device 2200. For example, when an identifier regarding a user input corresponding to an input of shaking for a certain time period, is received from the first external device 2100 and the second external device 2200, the mobile device 1000 may determine that the user input is generated by the collision between the first and second external devices 2100 and 2200.

In operation S1142, the mobile device 1000 may transmit an identifier associated with the first external device 2100, an identifier regarding the second external device 2200, and the identifier regarding the user input to the server 3000.

Since operations S1152 and S1162 respectively correspond to operations S542 and S552 of FIG. 5B, detailed descriptions thereof are omitted.

In operation S1172, the server 3000 may retrieve content about the first external device 2100 and the second external device 2200 by using the identifier regarding the first external device 2100 and the identifier regarding the second external device 2200 which are received from the mobile device 1000.

In operation S1182, the server 3000 may transmit the retrieved content to the mobile device 1000.

In operation S1192, the mobile device 1000 may display the content transmitted from the server 3000.

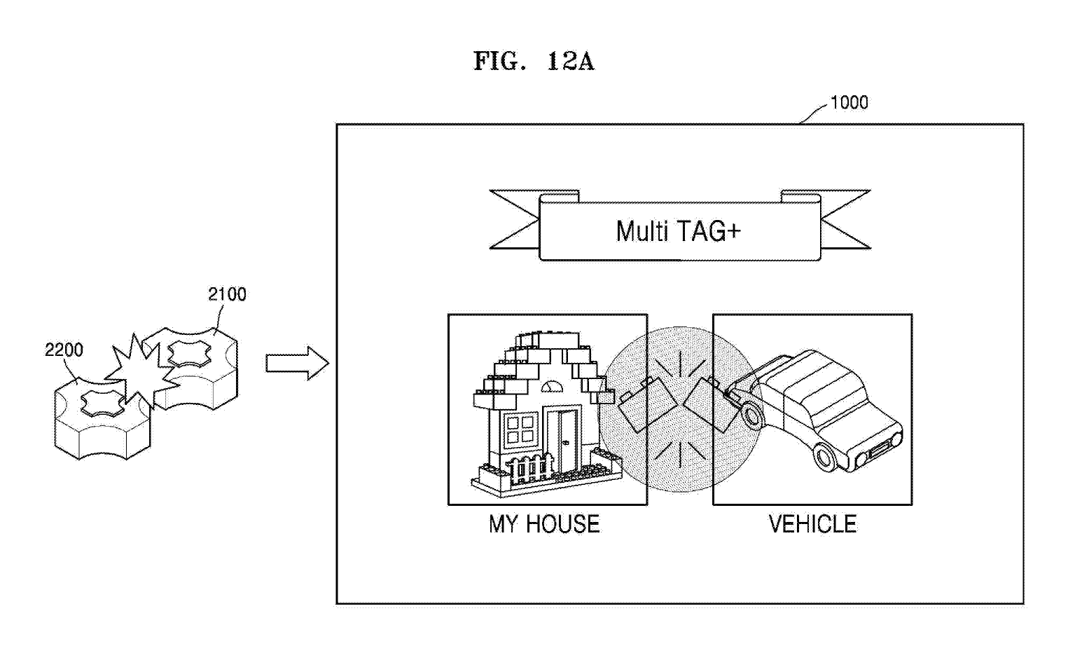

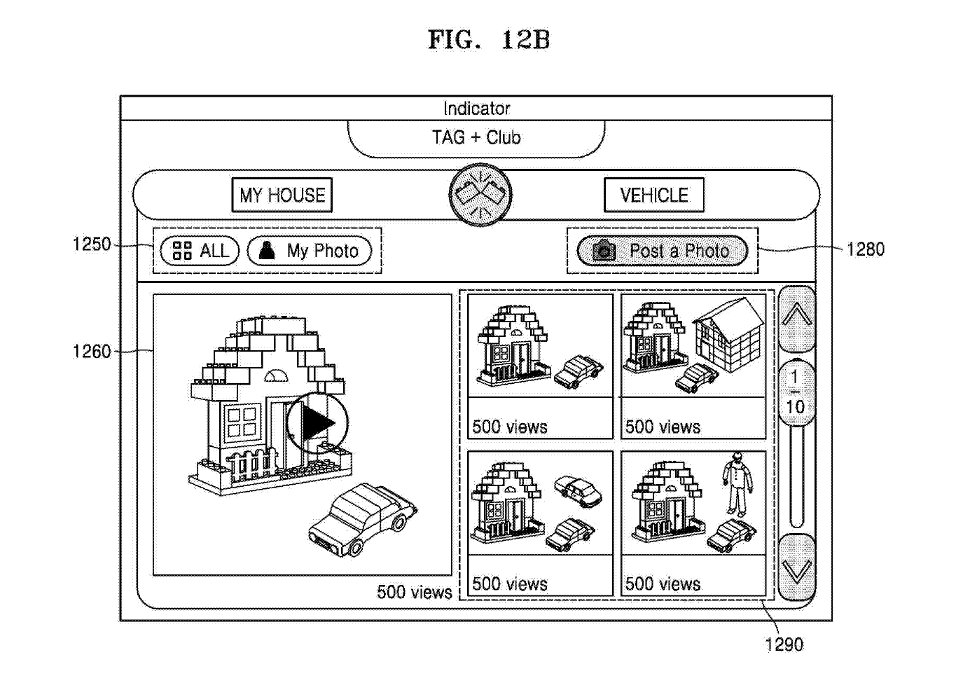

FIGS. 12A and 12B are diagrams of examples of providing the content about the external device 2000 when the identifier regarding the user input is the identifier indicating the collision between the external devices, that is, the first and second external devices 2100 and 2200, according to an exemplary embodiment.

For example, referring to FIG. 12A, when the first external device 2100 collides with the second external device 2200, the mobile device 1000 may display that the user input is determined as the collision between the first external device 2100 and the second external device 2200. In this case, a first toy, which corresponds to the first external device 2100 and is assembled as a house, and a second toy, which corresponds to the second external device 2200 and is assembled as a vehicle, may be displayed together.

Referring to FIG. 12B, the mobile device 1000 may display a video 1260 including a scene in which the toy assembled as the house and the toy assembled as the vehicle are used together. Also, a data list 1290 regarding the toys may be displayed. The data list 1290 may include images or thumbnails, but is not limited thereto. Since a filter mode 1250 and an image upload button 1280 of FIG. 12B respectively correspond to the filter mode 820 and the image upload button 850 of FIG. 8A, detailed descriptions thereof are omitted.

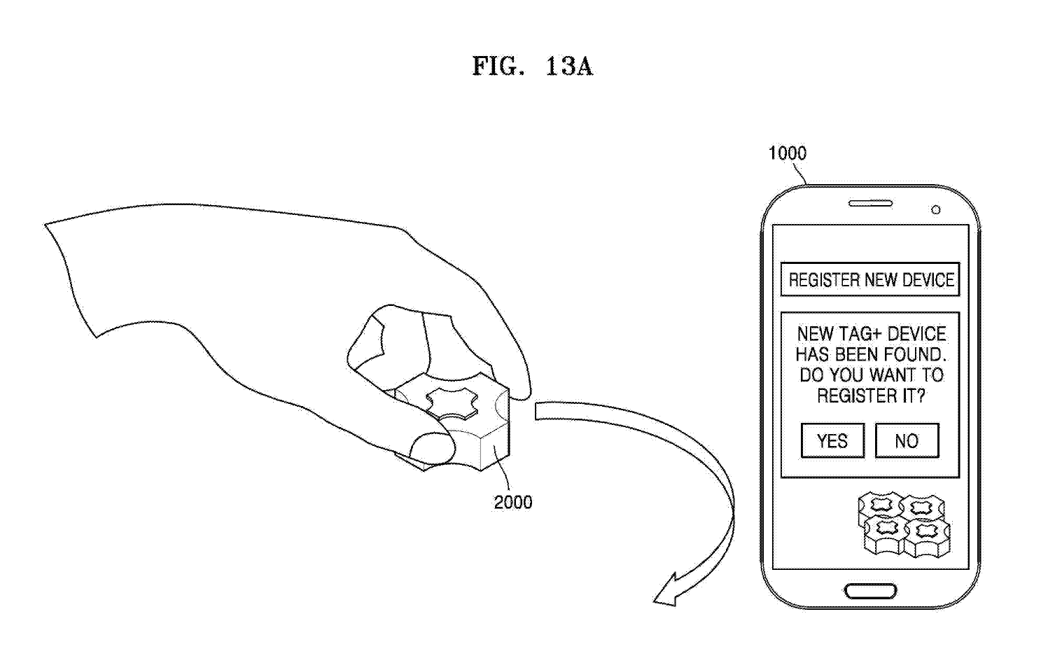

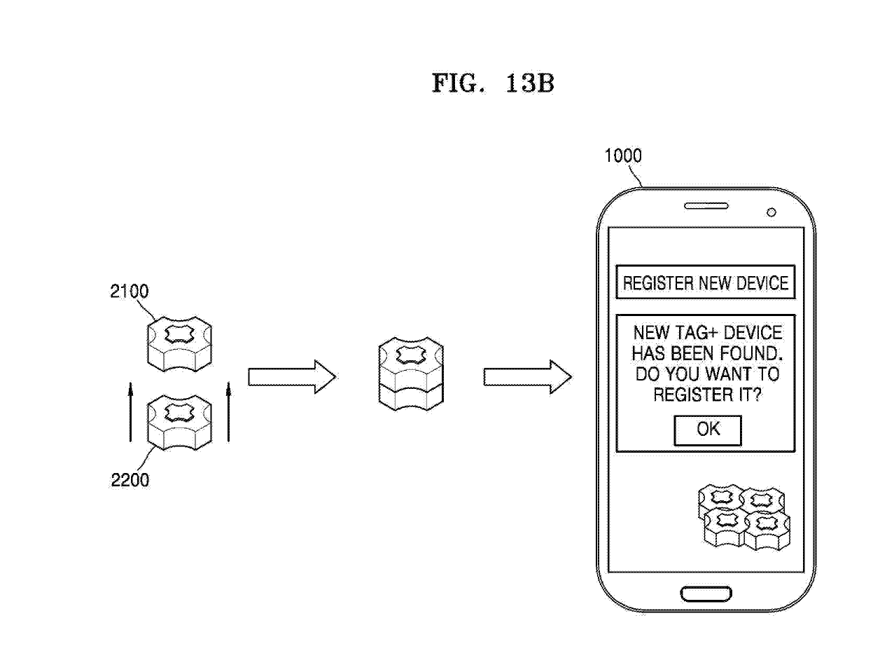

FIGS. 13A and 13B are diagrams of examples of registering the external device 2000 by the mobile device 1000, according to an exemplary embodiment.

The mobile device 1000 may register the external device 2000 based on the identifier regarding the user input that is input to the external device 2000, without an initial setting regarding the external device 2000.

For example, referring to FIG. 13A, when an input of moving the external device 2000 in a circle is identified, the external device 2000 may transmit an identifier regarding the input to the mobile device 1000. When the identifier regarding the user input is received from the external device 2000, the mobile device 1000 may display that the external device 2000 has been registered. In this case, the mobile device 1000 may allow the server 3000 to renew a user profile by transmitting the identifier regarding the external device 2000 to the server 3000.

Referring to FIG. 13B, in response to coupling the first external device 2100, which is already registered, to a new second external device 2200, the mobile device 1000 may register the second external device 2200. In this case, the mobile device 1000 may receive a different identifier regarding the user input according to a location where the first external device 2100 is coupled to the second external device 2200. When the first external device 2100 and the second external device 2200 are coupled, the identifier regarding the second external device 2200 or information about a product associated with the second external device 2200 may be transmitted to the first external device 2100 in a wired or wireless manner.

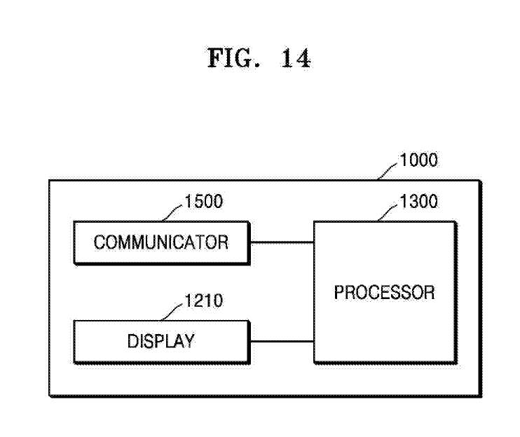

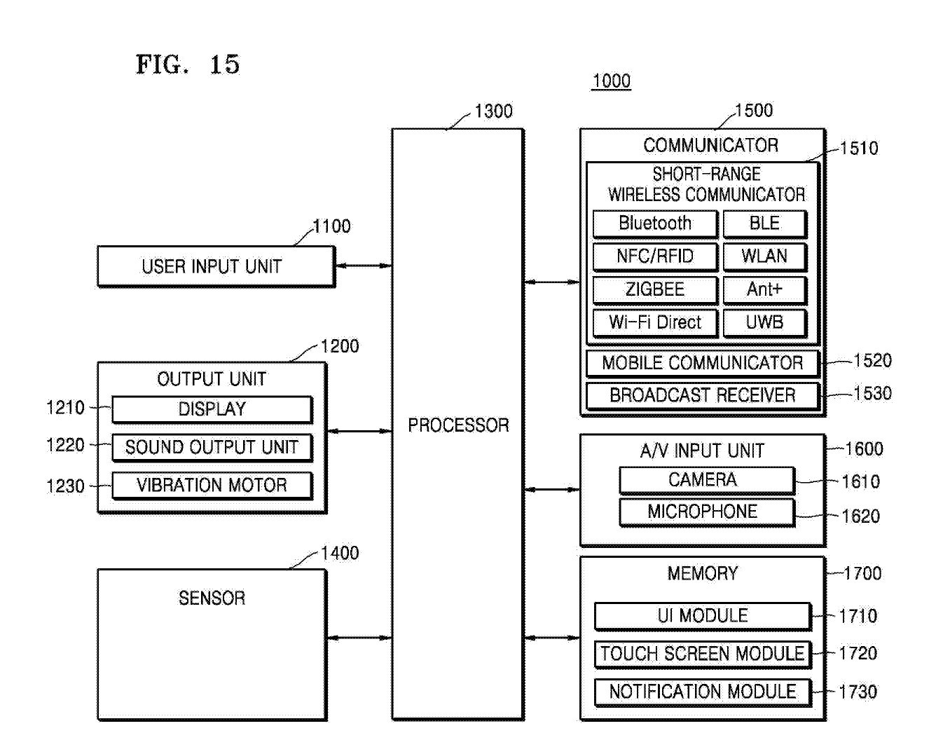

FIGS. 14 and 15 are block diagrams of the mobile device 1000 according to an exemplary embodiment.

As shown in FIG. 14, the mobile device 1000 according to an aspect of an exemplary embodiment may include a display 1210, the communicator 1500, and a processor 1300. However, not every component shown in FIG. 14 is necessary. The mobile device 1000 may be embodied by more or fewer components than the components shown in FIG. 14.

For example, as shown in FIG. 15, the mobile device 1000 according to an exemplary embodiment may further include a user input unit 1100, an output unit 1200, a sensor 1400, an audio/video (A/V) input unit 1600, and a memory 1700, in addition to the display 1210, the communicator 1500, and the processor 1300.

The user input unit 1100 may be a unit by which a user inputs data to control the memory 1700. For example, the user input unit 1100 may include a keypad, a dome switch, a touch pad (e.g., a touch capacitive type touch pad, a pressure resistive type touch pad, an infrared beam sensing type touch pad, a surface acoustic wave type touch pad, an integral strain gauge type touch pad, a Piezo effect type touch pad, or the like), a jog wheel, and a jog switch, but the present disclosure is not limited thereto.

The output unit 1200 may output an audio signal, a video signal, or a vibration signal, and may include the display 1210, a sound output unit 1220, a vibration motor 1230, or the like.

The display 1210 displays and outputs information that is processed in the mobile device 1000. For example, the display 1210 may display content received from the server 3000.

The sound output unit 1220 outputs audio data that is received from the communicator 1500 or is stored in the memory 1700.

The processor 1300 may generally control all operations of the mobile device 1000. For example, the processor 1300 may generally control the user input unit 1100, the output unit 1200, the sensor 1400, the communicator 1500, the A/V input unit 1600, etc. by executing programs stored in the memory 1700. Also, the processor 1300 may perform the functions of the mobile device 1000, which are described with reference to FIGS. 1 to 13B, by executing the programs stored in the memory 1700. For example, the processor 1300 may be one or more central processing units (CPUs).

The processor 1300 may receive/transmit data from/to the external device 2000 and the server 3000 through the communicator 1500. When receiving the content about the external device 2000 from the server 3000, the processor 1300 may execute an application for displaying the received content. In this case, the received content may be selected based on the identifier regarding the external device 2000 and the identifier regarding the user input that is input to the external device 2000. Also, the received content may be received from the server 3000 in order to provide a social media service. Also, the received content may be determined by the server 3000 based on information about the product associated with the external device 2000. In this case, the information may include at least one of a model name, a serial number, a manufacture number, and a product number of the product.

The content about the external device 2000 may include at least one of detailed information about using the product associated with the external device 2000, the GUI for uploading the data about the product associated with the external device 2000, the GUI for communicating with another user who uses a product that is identical to the product associated with the external device 2000, and a video including a scene in which respective products associated with the external devices 2000 are used together. However, the content is not limited thereto. In addition, the detail information may include at least one of a manual of the product, a tutorial video of the product, and information about other products associated with the product.

The identifier regarding the user input may indicate at least one of a button input, a touch input, and a motion input. For example, the user input identified by the external device 2000 may include at least one of an input of short pressing the button on the external device 2000, an input of long pressing the button, an input corresponding to a motion of shaking the external device 2000, and an input of colliding two external devices 2000. However, the user input is not limited thereto.

The sensor 1400 may detect a state of the mobile device 1000 or a state around the mobile device 1000 and may transmit detected information to the processor 1300. The sensor 1400 may include, for example, a motion sensor, an accelerometer, a gyroscopic sensor, a temperature sensor, a pressure sensor, etc.

The communicator 1500 may include one or more components for communication between the mobile device 1000 and the external device 2000, the server 3000, and another device. The other device may be a computing device such as the mobile device 1000 or a sensing device other than the external device 2000. However, one or more embodiments are not limited thereto. For example, the communicator 1500 may include a short-range wireless communicator 1510, a mobile communicator 1520, and a broadcast receiver 1530.

The short-range wireless communicator 1510 may include a Bluetooth communicator, a BLE communicator, an NFC communicator, a WLAN communicator, a Zigbee communicator, an IrDA communicator, a WFD communicator, a UWB communicator, an Ant+ communicator, or the like. However, the present disclosure is not limited thereto.

The mobile communicator 1520 may receive/transmit a wireless signal from/to at least one of a broadcast station, an external terminal, and the server 3000 via a wireless communication network. The wireless signal may include various types of data according to reception/transmission of a voice call signal, a video-call call signal, or a text message/multimedia message.

The broadcast receiver 1530 receives a broadcast signal and/or broadcast-related information from the outside through a broadcast channel. The broadcast channel may include a satellite channel and a terrestrial channel. According to an embodiment, the mobile device 1000 may not include the broadcast receiver 1530.

In addition, the communicator 1500 may receive, from the external device 2000, the identifier regarding the external device 2000 and the identifier regarding the user input that is input to the external device 2000. The communicator 1500 may transmit the identifier regarding the external device 2000 and the identifier regarding the user input to the server 3000 and may receive the content about the external device 2000 from the server 3000.

The A/V input unit 1600 is used to receive an input of an audio signal or a video signal, and may include a camera 1610, a microphone 1620, and the like. The camera 1610 may obtain an image frame such as a still image or a moving image by using an image sensor in a video call mode or a photographing mode. An image captured by the image sensor may be processed by the processor 1300 or a separate image processor.

The microphone 1620 may convert a received external audio signal into electrical voice data. For example, the microphone 1620 may receive an audio signal from an external device or a speaker. The microphone 1620 may receive an audio input of the user. The microphone 1620 may use various noise removal algorithms for removing noise generated during the receiving of the external audio signal.

The memory 1700 may store programs to process and control the processor 1100 or may store data input to or output from the mobile device 1000.

The memory 1700 may include at least one storage medium from among a flash memory-type storage medium, a hard disk-type storage medium, a multimedia card micro-type storage medium, card-type memories (e.g., a secure digital (SD) card, an extreme digital (XD) memory, and the like), a random access memory (RAM), a static random access memory (SRAM), a read-only memory (ROM), an electrically erasable programmable read-only memory (EEPROM), a programmable read-only memory (PROM), a magnetic memory, a magnetic disc, and an optical disc.

The programs stored in the memory 1700 may be classified into modules, for example, a user interface (UI) module 1710, a touch screen module 1720, and a notification module 1730, according to their functions.

The UI module 1710 may provide a specialized UI or GUI which interoperates with the mobile device 1000 according to applications. The touch screen module 1720 may detect a user's touch gesture on a touch screen and may transmit information about the touch gesture to the processor 1300. The touch screen module 1720 according to an aspect of an exemplary embodiment may recognize and analyze touch codes. The touch screen module 1720 may be configured as separate hardware including a controller.

The notification module 1730 may generate a signal for notifying the occurrence of events in the mobile device 1000. Examples of events occurring in the mobile device 1000 may be reception of a call signal, reception of a message, a key signal input, a schedule notification, and the like.

In an exemplary embodiment, a device for receiving and displaying content about the external device 2000 may be defined as the mobile device 1000, but may be a non-mobile device. The non-mobile device may be a digital broadcasting terminal, a navigation device, a kiosk, a home appliance, or other non-mobile computing devices, but one or more embodiments are not limited thereto. Moreover, a mobile device and a non-mobile device may include all types of devices that are capable of receiving, from the external device 2000, the identifier regarding the user input that is input to the external device 2000, transmitting the identifier to the server 3000, receiving the content about the external device 2000 from the server 3000, and providing the received content.

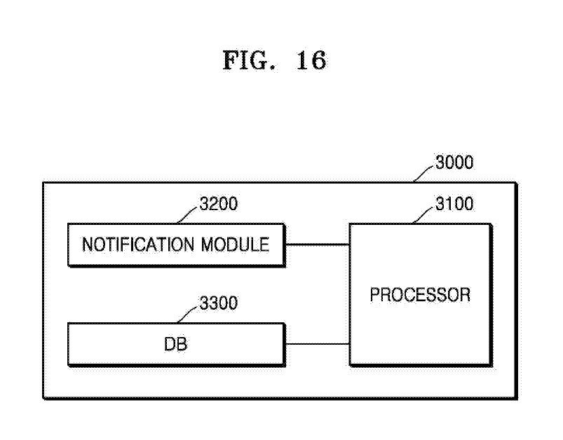

FIG. 16 is a block diagram of the server 3000 according to an exemplary embodiment.

Referring to FIG. 16, the server 3000 according to an exemplary embodiment may include a communicator 3200, a database (DB) 3300, and a processor 3100.

The communicator 3200 may include one or more components for communicating with the mobile device 100 and other devices.

The DB 3300 may store data used to select the content about the external device 2000.

The processor 3100 may generally control all operations of the mobile device 1000. For example, the processor 3100 may generally control the DB 3300, the communicator 3200, etc. by executing programs stored in the DB 3300 of the server 3000. The processor 3100 may perform some of the operations of the server 3000, which are described with reference to FIGS. 1 to 13B, by executing the programs stored in the DB 3300.

The processor 3100 may select content to be transmitted to the mobile device 1000, based on the identifier regarding the external device 2000 and the identifier regarding the user input that is input to the external device 2000.

Also, the processor 3100 may produce and manage a user profile by using the identifier regarding the mobile device 1000 and the identifier regarding the external device 2000, which are received from the mobile device 1000.

Some exemplary embodiments can be embodied as a non-transitory computer-readable recording medium, for example, a program module, which includes instructions executable by a computer. The non-transitory computer-readable recording medium may be an arbitrarily available medium that may be accessed by a computer and may include a volatile medium, a non-volatile medium, a removable medium, and a non-removable medium. Also, the non-transitory computer-readable recording medium may include a computer storage medium and a communication medium. The computer storage medium includes a volatile medium, a non-volatile medium, a removable medium, and a non-removable medium that is embodied by an arbitrary method or technology in order to store information such as computer-readable instructions, data structures, program modules, or other types of data. The communication medium may generally include computer-readable instructions, data structures, program modules, data having modulated data signals, or other transmission mechanisms and may also include an arbitrary information transmission medium.

Also, the “unit” may be implemented as a hardware component such as a processor or a circuit, and/or a software component executed by a hardware component such as a processor.

It should be understood that embodiments described herein should be considered in a descriptive sense only and not for purposes of limitation. Descriptions of features or aspects within each embodiment should typically be considered as available for other similar features or aspects in other embodiments. For example, components of a single type may be executed in a distributed manner, and components of a distributed type may be integrated.

While one or more exemplary embodiments have been described with reference to the figures, it will be understood by one of ordinary skill in the art that various changes in form and details may be made therein without departing from the spirit and scope as defined by the following claims.

What is claimed is:

1. A mobile device comprising:
a memory storing a program;
a communicator configured to exchange data with an external device and a server; and
a processor configured to provide content about the external device by executing the program,
wherein the program comprises instructions to perform:
receiving, from the external device, an identifier regarding the external device and an identifier regarding a user input that is input to the external device;
transmitting, to the server, the identifier regarding the external device and the identifier regarding the user input;
receiving, from the server, content about the external device and the user input, based on the identifier regarding the external device and the identifier regarding the user input; and
displaying the received content on a screen.

2. The mobile device of claim 1, wherein the received content comprises content received from the server to provide a service associated with a social media.

3. The mobile device of claim 1, wherein the received content comprises content determined by the server based on information about a product associated with the external device.

4. The mobile device of claim 3, wherein the information about the product comprises at least one of a model name, a serial number, a manufacture number, and a product number of the product.

5. The mobile device of claim 1, wherein, in the receiving of the content, detailed information about using a product associated with the external device is received from the server in response to the identifier regarding the user input being a first identifier.

6. The mobile device of claim 1, wherein, in the receiving of the content, a graphical user interface (GUI) for uploading data about a product associated with the external device is received from the server in response to the identifier regarding the user input being a second identifier.

7. The mobile device of claim 1, wherein, in the receiving of the content, a GUI for communicating with another user who uses an identical product to a product associated with the external device is received from the server, in response to the identifier regarding the user input being a third identifier.

8. The mobile device of claim 7, wherein the program further comprises additional instructions to perform establishing a video call to the other user by using the GUI for communicating with the other user.

9. The mobile device of claim 1, wherein, in response to the identifier regarding the user input indicating a user input of colliding the external device with another external device, the receiving of the content comprises receiving, from the server, a video comprising a scene in which a first product associated with the external device and a second product associated with the other external device are used together.

10. The mobile device of claim 1, wherein the program further comprises additional instructions to perform:
displaying a GUI for determining whether to display the content about the external device in response to the identifier regarding the external device and the identifier regarding the user input being received; and
determining whether to display the content about the external device, based on an additional user input through the displayed GUI.

11. A method of providing, by a mobile device, content about an external device, the method comprising:
receiving, from the external device, an identifier regarding the external device and an identifier regarding a user input that is input to the external device;
transmitting, to a server, the identifier regarding the external device and the identifier regarding the user input;
receiving, from the server, content about the external device and the user input, based on the identifier regarding the external device and the identifier regarding the user input; and
displaying the received content on a screen.

12. The method of claim 11, wherein the received content comprises content received from the server to provide a service associated with a social media.

13. The method of claim 11, wherein the received content comprises content determined by the server based on information about a product associated with the external device.

14. The method of claim 13, wherein the information about the product comprises at least one of a model name, a serial number, a manufacture number, and a product number of the product.

15. The method of claim 11, wherein, the receiving the content comprises receiving, from the server, detailed information about using a product associated with the external device in response to the identifier regarding the user input being a first identifier.

16. The method of claim 11, wherein, the receiving the content comprises receiving, from the server, a graphical user interface (GUI) for uploading data about a product associated with the external device in response to the identifier regarding the user input being a second identifier.

17. The method of claim 11, wherein, the receiving the content comprises receiving, from the server, a GUI for communicating with another user who uses an identical product to a product associated with the external device, in response to the identifier regarding the user input being a third identifier.

18. The method of claim 17, further comprising establishing a video call to the other user by using the GUI for communicating with the other user.

19. The method of claim 11, wherein, in response to the identifier regarding the user input indicating a user input of colliding the external device with another external device, the receiving the content comprises receiving, from the server, a video comprising a scene in which a first product associated with the external device and a second product associated with the other external device are used together.

20. A non-transitory computer-readable recording medium having recorded thereon a program which, when executed by a computer, performs operations comprising:
receiving, from the external device, an identifier regarding the external device and an identifier regarding a user input that is input to the external device;
transmitting, to a server, the identifier regarding the external device and the identifier regarding the user input;
receiving, from the server, content about the external device and the user input, based on the identifier regarding the external device and the identifier regarding the user input; and
displaying the received content on a screen.
